(19) United States
(12) Patent Application Publication
(10) Pub. No.: US 2009/0004287 A1
(43) Pub. Date: Jan. 1, 2009

(54) Disinfectant formulations containing quaternary ammonium compounds and hydrogen peroxide

(76) Inventors: Joseph Kimler, Yardville, NJ (US); Michael Chiang, Flemington, NJ (US)

Correspondence Address: FISHER, CHRISTEN & SABOL, 1120 20TH STREET, NW, SOUTH TOWER, SUITE 750, WASHINGTON, DC, 20036, US

(21) Appl. No.: 12/010,950

(22) Filed: Jan. 31, 2008

Related U.S. Application Data
(60) Provisional application No. 60/898,411, filed on Jan. 31, 2007.

(30) Foreign Application Priority Data
Mar. 16, 2007 (EP) 07005428

(51) Int. Cl. A01N 59/00; A01P 1/00; A01P 3/00

(52) U.S. Cl. 424/616

(57) ABSTRACT

Disinfectant compositions having at least one biocidal quaternary ammonium carbonate and/or bicarbonate and hydrogen peroxide. A method for killing or inhibiting the growth of microorganisms, algae and fungi involves applying the disinfectant compositions. Methods involving inhibiting the decomposition of aqueous hydrogen peroxide solutions and involving inhibiting the corrosive action of aqueous hydrogen peroxide on metals.

This application has priority benefit of U.S. Provisional Application No. 60/898,411, filed on Jan. 31, 2007, and of European Patent Application No. EP 07005428, filed on Mar. 16, 2007.

The invention relates to disinfectant compositions comprising hydrogen peroxide and quarternary ammonium compounds. It further relates to a method for killing or inhibiting the growth of microorganisms by applying a disinfectant composition according to the invention. Another object of the invention is a method for inhibiting the decomposition of aqueous solutions of hydrogen peroxide. Still another object of the invention is a method for inhibiting the corrosive action of hydrogen peroxide solutions on metals.

The use of quaternary ammonium compounds as biocides is well known (see e.g. Kirk-Othmer's Encyclopedia of Chemical Technology, 3^{rd} Ed., Vol. 7, pp. 793-832, in particular pp. 815-818). Also well known is the use of hydrogen peroxide as an antiseptic (Kirk-Othmer, loc. cit., p. 807). Each of these compounds have their own weaknesses and strengths. For example, quaternary ammonium compounds are less effective in the presence of hard water and surfactants, while hydrogen peroxide is less affected by these factors. On the other hand, quaternary ammonium compounds are more stable in solution, and are biologically efficacious at lower concentrations than hydrogen peroxide. A problem with both halogenated quaternary ammonium compounds and hydrogen peroxide is that they are corrosive to metals.

Accordingly, the problem to be solved by the present invention was to provide disinfectant compositions comprising quaternary ammonium compounds and hydrogen peroxide which are chemically stable and non-corrosive to metals.

According to the invention, this problem has been solved by the disinfectant compositions of the invention.

It has been found that biocidal quaternary ammonium carbonates and bicarbonates, more specifically, benzylalkyl- or dialkyldimethylammonium salts containing either carbonate, bicarbonate, or a combination thereof, as the anion, used in combination with hydrogen peroxide make a highly effective disinfectant which is chemically stable and non-corrosive to metals.

Provided is a disinfectant composition comprising at least one biocidal quaternary ammonium compound selected from the group consisting of quaternary ammonium carbonates and quarternary ammonium bicarbonates; and hydrogen peroxide.

In a preferred embodiment, the quaternary ammonium carbonates and bicarbonates have the formulas

(R¹R²R³R⁴N⁺)₂CO₃²⁻ (I)

and

R¹R²R³R⁴N⁺HCO₃⁻ (II),

wherein R¹ is benzyl or C₈₋₂₀ alkyl;

R² is selected from the group consisting of C₈₋₂₀ alkyl and —[(CH₂)₂—O]ₙ—R⁵, wherein n is an integer from 1 to 20 and R⁵ is selected from the group consisting of hydrogen, phenyl and alkyl-substituted phenyl; and R³ and R⁴ are independently C₁₋₂₀ alkyl.

Here and hereinbelow the expression “C₁₋₂₀ alkyl” is to be understood to comprise all linear or branched alkyl groups having 1 to 20 carbon atoms, including, but not limited to, methyl, ethyl, propyl, isopropyl, butyl, isobutyl, sec-butyl, tert-butyl, pentyl, isopentyl, tert-pentyl, neopentyl, hexyl, heptyl, octyl, nonyl, decyl, dodecyl, tetradecyl, hexadecyl, octadecyl and icosyl. Accordingly, the expression “C₈₋₂₀ alkyl” is to be understood to comprise all linear or branched alkyl groups having 8 to 20 carbon atoms.

The expression “alkyl-substituted phenyl” is to understood to comprise any phenyl group bearing from one to five alkyl groups, in particular C₁₋₂₀ and preferably C₁₋₈ alkyl groups as substituents.

More preferably, R¹ and R² are C₈₋₂₀ alkyl and R³ and R⁴ are methyl.

Still more preferably, R¹ and R² are C₁₀ alkyl, most preferably n-decyl.

Preferably, the weight ratio of quaternary ammonium compound(s) to hydrogen peroxide is from 1:100 to 2:1, more preferably from 1:20 to 1:1, and even more preferably from 1:5 to 1:1.

Another object of the invention is a method for killing or inhibiting the growth of microorganisms, algae and/or fungi, said method comprising applying a disinfectant composition as described above to a substrate in or on which said microorganisms, algae and/or fungi are growing or may grow.

Still another object of the invention is a method for inhibiting the decomposition of aqueous solutions of hydrogen peroxide, said method comprising adding at least one quaternary ammonium compound selected from the group consisting of quaternary ammonium carbonates and quaternary ammonium bicarbonates to said aqueous solution of hydrogen peroxide.

Yet another object of the invention is a method for inhibiting the corrosive action of aqueous solutions of hydrogen peroxide on metal surfaces, said method comprising adding at least one quaternary ammonium compound selected from the group consisting of quaternary ammonium carbonates and quaternary ammonium bicarbonates to said aqueous solution of hydrogen peroxide.

Preferably, the quaternary ammonium carbonates and bicarbonates to be employed in the above methods for inhibiting the decomposition of aqueous solutions of hydrogen peroxide or their corrosive action on metal surfaces have the formulas

(R¹R²R³R⁴N⁺)₂CO₃²⁻ (I)

and

R¹R²R³R⁴N⁺HCO₃⁻ (II),

wherein R¹ is benzyl or C₈₋₂₀ alkyl;

R² is selected from the group consisting of C₁₋₂₀ alkyl and —[(CH₂)₂—O]ₙ—R⁵, wherein n is an integer from 1 to 20 and R⁵ is selected from the group consisting of hydrogen, phenyl and alkyl-substituted phenyl;

and R³ and R⁴ are independently C₁₋₂₀ alkyl.

The weight ratio of quaternary ammonium compound(s) to hydrogen peroxide in the above method is from 1:100 to 2:1, preferably from 1:20 to 1:1.

The following non-limiting examples will illustrate the invention. All concentrations in percent or ppm are by weight unless otherwise noted.

### EXAMPLE 1

### Hydrogen Peroxide Stability in the Presence of Didecyldimethylammonium Bicarbonate/-Carbonate

TABLE 1

| | % Hydrogen Peroxide Concentration at Time/Temperature | | | | |
|---|---|---|---|---|---|
| Chemical Composition | Initial | 1 Week/RT | 1 Week/40° C. | 1 Month/RT | 1 Month/40° C. |
| 3.0% H₂O₂ | 3.11 | 2.99 | 2.74 | 2.85 | 1.82 |
| 2.85% H₂O₂/0.25% Quat | 3.07 | 3.05 | 3.01 | 2.85 | 2.75 |
| 2.25% H₂O₂/1.25% Quat | 2.34 | 2.33 | 2.18 | 2.14 | 1.78 |

Quat = didecyldimethylammonium carbonate/bicarbonate
RT = room temperature
n.d. = not determined
The accuracy of the analytical method used is ±3% on a relative basis

### EXAMPLE 2

### Efficacy of Didecyldimethylammonium Bicarbonate/Carbonate with Hydrogen Peroxide Against P. aeruginosa

### Materials/Results:

All solutions were diluted in water of 400 ppm hardness and all concentrations were expressed in ppm. Each of the solutions was tested in 4 replicates as described below. The numbers in Table 2 below indicate the number of “positive” cells or ineffective disinfection of 4 replicates. Various contact times noted on the tables were evaluated.

### Procedure:

Flat bottom microplate wells were inoculated with 15 μL each of a suspension of 10% P. aeruginosa+5% fetal bovine serum in a saline solution, 4.5×10⁷ cfu/mL using a Quadra Tower 400 Series High Throughput apparatus (Tomtec Inc., Hamden, Conn.). The plates were dried with cover open for 40 minutes at 36° C. Then, 120 μL of each test substance was transferred from the deep-well block to the test wells. The test organisms were exposed to the test substance for different contact times, after which the substances were removed with the Quadra and 150 μL of modified AOAC Letheen neutralizer+0.5% Na thiosulfate/growth broth was added to each well. The microplates were incubated at 36° C. for 24 hours and scored for growth/no growth.

TABLE 2

| Concentration/ppm | | Positive cells out of a total of 4 after: | | | | | | | |
|---|---|---|---|---|---|---|---|---|---|
| Quat | H₂O₂ | 5 min | 10 min | 11 min | 13 min | 16 min | 20 min | 21 min | 25 min |
| — | 2,000 | 0 | 0 | 0 | 0 | 0 | 0 | 0 | 0 |
| — | 600 | 4 | 4 | 2 | 0 | 0 | 0 | 0 | 0 |
| 500 | — | 4 | 4 | 4 | 4 | 1 | 0 | 1 | 0 |
| 500 | 600 | 4 | 2 | 0 | 0 | 0 | 0 | 0 | 0 |
| 700 | 600 | 0 | 0 | 0 | 0 | 0 | 0 | 0 | 0 |
| 500 | 1,000 | 0 | 0 | 0 | 0 | 0 | 0 | 0 | 0 |

1. A disinfectant composition comprising:
(i) at least one biocidal quaternary ammonium compound selected from the group consisting of quaternary ammonium carbonates and quaternary ammonium bicarbonates; and
(ii) hydrogen peroxide.

2. The disinfectant composition of claim 1, wherein the quaternary ammonium carbonates and bicarbonates have the formulas, respectively:
(R¹R²R³R⁴N⁺)₂CO₃ (I)
and
R¹R²R³R⁴N⁺HCO₃ (II),
wherein R¹ is optionally substituted benzyl or C₈₋₂₀ alkyl;
R² is selected from the group consisting of C₈₋₂₀ alkyl and —[(CH₂)₂—O]ₙ—R⁵, wherein n is an integer from 1 to 20 and R⁵ is selected from the group consisting of hydrogen, phenyl and alkyl-substituted phenyl; and
R³ and R⁴ are independently C₁₋₂₀ alkyl.

3. The disinfectant composition of claim 2, wherein R¹ and R² are C₈₋₂₀ alkyl and R³ and R⁴ are methyl.

4. The disinfectant composition of claim 3, wherein R¹ and R² are C₁₀ alkyl.

5. The disinfectant composition of claim 4, wherein the weight ratio of the at least one quaternary ammonium compound to the hydrogen peroxide is from 1:100 to 2:1.

6. The disinfectant composition of claim 5, wherein the weight ratio of the at least one quaternary ammonium compound to the hydrogen peroxide is from 1:20 to 1:1.

7. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates; and
(ii) hydrogen peroxide,
to a substrate in or on which said microorganisms, algae and/or fungi are growing or may grow.

8. (canceled)

9. A method for inhibiting the corrosive action of aqueous solutions of hydrogen peroxide on metal surfaces, said method comprising adding at least one quaternary ammonium compound selected from the group consisting of quaternary ammonium carbonates and quaternary ammonium bicarbonates to said aqueous solution of hydrogen peroxide.

10. The method of claim 9, wherein the quaternary ammonium carbonates and bicarbonates have the formulas, respectively:
(R¹R²R³R⁴N⁺)₂CO₃ (I)
and
R¹R²R³R⁴N⁺HCO₃ (II),
wherein R¹ is optionally substituted benzyl or C₈₋₂₀ alkyl;
R² is selected from the group consisting of C₈₋₂₀ alkyl and —[(CH₂)₂O]ₙ—R⁵, wherein n is an integer from 1 to 20 and R⁵ is selected from the group consisting of hydrogen, phenyl and alkyl-substituted phenyl; and
R³ and R⁴ are independently C₁₋₂₀ alkyl.

11. The method of claim 10, wherein the weight ratio of the at least one quaternary ammonium compound to the hydrogen peroxide is from 1:20 to 1:1.

12. The disinfectant of claim 6 wherein the weight ratio of at least one quarternary ammonium compound to the hydrogen peroxide is from 1:5 to 1:1.

13. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates and quarternary ammonium bicarbonates having the formulas, respectively:
(R¹R²R³R⁴N⁺)₂CO₃ (I)
and
R¹R²R³R⁴N⁺HCO₃ (II),
wherein R¹ is optionally substituted benzyl or C₈₋₂₀ alkyl;
R² is selected from the group consisting of C₈₋₂₀ alkyl and —[(CH₂)₂—O]—R⁵, wherein n is an integer from 1 to 20 and R⁵ is selected from the group consisting of hydrogen, phenyl and alkyl-substituted phenyl; and
R³ and R⁴ are independently C₁₋₂₀ alkyl; and
(ii) hydrogen peroxide,
to a substrate in or on which said microorganisms, algae and/or fungi are growing or may grow.

14. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates having the formulas, respectively:
(R¹R²R³R⁴N⁺)₂CO₃ (I)
and
R¹R²R³R⁴N⁺HCO₃ (II),
wherein R¹ and R² are C₈₋₂₀ alkyl;
R⁵ is selected from the group consisting of hydrogen, phenyl and alkyl-substituted phenyl; and
R³ and R⁴ are methyl; and
(ii) hydrogen peroxide,
to a substrate in or on which said microorganisms, algae and/or fungi are growing or may grow.

15. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates having the formulas, respectively:
(R¹R²R³R⁴N⁺)₂CO₃ (I)
and
R¹R²R³R⁴N⁺HCO₃ (II),
wherein R¹ and R² are C₁₀ alkyl;
R⁵ is selected from the group consisting of hydrogen, phenyl and alkyl-substituted phenyl; and
R³ and R⁴ are methyl; and
(ii) hydrogen peroxide,
to a substrate in or on which said microorganisms, algae and/or fungi are growing or may grow.

16. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates having the formulas, respectively:
(R¹R²R³R⁴N⁺)₂CO₃ (I)
and
R¹R²R³R⁴N⁺HCO₃ (II),
wherein R¹ and R² are C₁₀ alkyl;
R⁵ is selected from the group consisting of hydrogen, phenyl and alkyl-substituted phenyl; and
R³ and R⁴ are methyl; and
(ii) hydrogen peroxide,
the weight ratio of the at least one quarternary ammonium compound to the hydrogen peroxide is from 1:100 to 2:1,
to a substrate in or on which said microorganisms, algae and/or fungi are growing or may grow.

17. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates having the formulas, respectively:
(R¹R²R³R⁴N+)₂CO₃ (I)
and
R¹R²R³R⁴N⁺HCO₃ (II),
wherein R¹ and R² are C₁₀ alkyl;
R⁵ is selected from the group consisting of hydrogen, phenyl and alkyl-substituted phenyl; and
R³ and R⁴ are methyl; and
(ii) hydrogen peroxide,
the weight ratio of the at least one quarternary ammonium compound to the hydrogen peroxide is from 1:20 to 1:1,
to a substrate in or on which said microorganisms, algae and/or fungi are growing or may grow.

18. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates having the formulas, respectively:
(R¹R²R³R⁴N+)₂CO₃ (I)
and
R¹R²R³R⁴N⁺HCO₃ (II),
wherein R¹ and R² are C₁₀ alkyl;
R⁵ is selected from the group consisting of hydrogen, phenyl and alkyl-substituted phenyl; and
R³ and R⁴ are methyl; and
(ii) hydrogen peroxide,
the weight ratio of the at least one quarternary ammonium compound to the hydrogen peroxide is from 1:5 to 1:1,
to a substrate in or on which said microorganisms, algae and/or fungi are growing or may grow.

19. A method for killing or inhibiting the growth of microorganisms, algae and/or fungi, said method comprising applying the disinfectant composition comprising:
(i) at least one biocidal quaternary ammonium compound selected from the group consisting of quaternary ammonium carbonates and quaternary ammonium bicarbonates; and
(ii) hydrogen peroxide,
the weight ratio of the at least one quarternary ammonium compound to the hydrogen peroxide is from 1:5 to 1:1,
to a substrate in or on which said microorganisms, algae and/or fungi are growing or may grow.

20. The method of claim 7, wherein the weight ratio of the at least one quarternary ammonium compound to the hydrogen peroxide is from 1:100 to 2:1.

21. The method of claim 7, wherein the weight ratio of the at least one quaternary ammonium compound to the hydrogen peroxide is from 1:20 to 1:1.

22. The method of claim 9, wherein the weight ratio of the at least one quaternary ammonium compound to the hydrogen peroxide is from 1:20 to 1:1.
